(19) United States
(12) Patent Application Publication
(10) Pub. No.: US 2005/0260397 A1
(43) Pub. Date: Nov. 24, 2005

(54) Plastic foam material and its use

(76) Inventors: Rainer Ohlinger, Hannover (DE); Thomas Wempe, Ostercappeln (DE)

Correspondence Address: FAY, SHARPE, FAGAN, MINNICH & MCKEE, LLP, Seventh Floor, 1100 Superior Avenue, Cleveland, OH, 44114-2518, US

(21) Appl. No.: 10/975,134

(22) Filed: Oct. 28, 2004

(30) Foreign Application Priority Data
May 21, 2004 (DE) 10 2004 024 157.6

(51) Int. Cl. B32B 3/26; B32B 5/22

(52) U.S. Cl. 428/304.4; 428/317.9

(57) ABSTRACT

A plastic foam material based on polyolefins containing 50-90 wt. % of polypropylene-based plastic and 10-50 wt. % of polyethylene-based plastic with a melt flow index MFI (190° C./2.16 kg) of less than 50 g/10 min is described, where the plastic foam material has a density of 0.03-0.2 g/cm³. This plastic foam material is characterized in that it contains 20-70 wt. % of crosslinked polyolefin, in that the polyethylene-based plastic has a melt flow index MFI (190° C./2.16 kg) of less than 2 g/10 min and more than 0.05 g/10 min, and in that the polypropylene-based plastic has a molecular weight (weight-average molecular weight) of 150,000-600,000 g/mol. This product can be used to particular advantage for the production of interior linings of motor vehicles and the like. In particular, it has superior elongation values at room temperature.

The invention pertains to a plastic foam material based on polyolefins containing 50-90 wt. % of polypropylene-based plastic and 10-50 wt. % of polyethylene-based plastic with a melt flow index MFI (190° C./2.16 kg) of less than 50 g/10 min, where the plastic foam material has a density of 0.03-0.2 g/cm³, and to its use in motor vehicles, airplanes and the like, especially for the production of interior linings or parts of interior linings.

Plastic foam materials of the type indicated above are described in EP 0,704,476 B1. This document describes a plastic foam material consisting of a polyolefin-based composition consisting of 40-95 wt. % of propylene-based plastics with a melt flow index (MFI) of 0.05-12 g/10 min and 5-60 wt. % of polyethylene-based plastics with a melt flow index (MFI) of 2-50 g/10 min. 20-65 wt. % of the plastic foam material consists of crosslinked material, and the foam material has a density of 0.02-0.2 g/cm³. 55-95 wt. % of the crosslinked fraction should consist of crosslinked polypropylene, and 5-45 wt. % should consist of crosslinked polyethylene. The general process by which a plastic material of this type is produced is as follows: Approximately 40-95 wt. % of a polypropylene-based plastic and approximately 5-60 wt. % of a polyethylene-based plastic are mixed with a crosslinking agent and a foaming agent to produce the plastic composition. A sheet is produced from this mixture by a process such as extrusion. This sheet is exposed to a source of ionizing radiation to obtain a crosslinked sheet. The dose of the ionizing radiation should be 1.0-6.0 Mrad. The ionizing treatment is continued until the amount of crosslinked material in the plastic composition reaches a value of 20-65 wt. %. The crosslinked plastic sheet is then heated to obtain a plastic foam material with a density of 0.02-0.2 g/cm³. This can be done in a conventional foaming oven at a temperature of approximately 250° C., as a result of which the incorporated foaming agent is thermally decomposed and thus produces the plastic foam material.

The known technical principle has the particular goal of producing a plastic foam material which has superior forming properties; which can be effectively applied to the surfaces of substrates; and which offers superior heat resistance, improved stretchability at high temperatures, and superior secondary treatment properties. According to the disclosure of EP 0,704,476 B1, the defined boundary conditions must be strictly observed to achieve these goals. This is especially true for the MFI value of the polyethylene-based plastic. Disadvantageous effects with respect to the forming process will occur if the MFI value of the polyethylene-based plastic should fall below 2 g/10 min. In such cases, it would not be possible to produce the desired products from the plastic foam material. In addition, the extrusion of the plastic foam material is said to become largely impossible when the MFI value of the polyethylene-based plastic falls below the indicated critical value of 2 g/10 min. An MFI value of approximately 2 g/10 min is said to impair in particular the overall appearance of the plastic foam material. In addition, the compatibility between the polyethylene and the polypropylene or a material based on polypropylene is also said to be impaired. EP 0,704,476 B1 thus provides strict instructions, according to which the MFI value of the selected polyolefin or of the polyolefin copolymer used for the production of the known plastic foam material may not fall below 2 g/10 min, because otherwise the desired product will not be obtained.

The surprising discovery has been made that, when the attempt is made to implement the technical principle of EP 0,704,476 B1 described above, the previously explained problems encountered when the MFI value of the polyethylene or of the polyethylene-based plastic falls below 2 g/10 min will not occur when the work is carried out according to a procedure to be described later in detail and to be illustrated by the examples of the present application. The reason for this will be explained in detail.

The object of the invention is therefore a plastic foam material based on polyolefins containing 50-90 wt. % of polypropylene-based plastic and 10-50 wt. % of polyethylene-based plastic with a melt flow index (190° C./2.16 kg) of less than 50 g/10 min, where the plastic foam material has a density of 0.03-0.2 g/cm³, characterized in that the plastic foam material contains 20-70 wt. % of crosslinked polyolefin, in that the polyethylene-based plastic has a melt flow index MFI (190° C./2.16 kg) of less than 2 g/10 min and more than 0.05 g/10 min; and in that the polypropylene-based plastic has a molecular weight (weight-average molecular weight) of 150,000-600,000 g/mol.

The invention can be realized advantageously in many ways. The advantages discussed below are achieved especially when the polypropylene-based plastic has a molecular weight (weight-average molecular weight) of 150,000-450,000 g/mol. Especially good results are obtained when the polypropylene-based plastic has a molecular weight of 150,000-300,000 g/mol, preferably of 150,000-250,000 g/mol, and even more preferably of less than 230,000 g/mol.

It has also been found to be especially advantageous for 55-95 wt. % of the crosslinked polyolefin component to consist of polypropylene-based plastic and for 545 wt. % to consist of polyethylene-based plastic. An especially preferred framework is between approximately 60-80 wt. % of polypropylene and 40-20 wt. % of polyethylene. These percentages by weight are based on the sum of polypropylene and polyethylene. The overall framework applicable here, according to which the crosslinked polyolefin component is present in the amount of 20-70 wt. %, is essential. According to the preferred framework, the crosslinked polyolefin constitutes approximately 30-60 wt. % of the plastic foam material.

There are various methods which can be used to determine the extent to which the polyolefin component of the plastic foam material according to the invention is crosslinked. One possibility is to measure the corresponding gel content; in this case, the crosslinked polymer portion is determined by extraction with xylene. This is done at a temperature of 145° C. The crosslinked, insoluble portion can be dried and then expressed as a percentage of the original weight of the foam sample. The percentages of the crosslinked material accounted for by the polyethylene-based plastic and the polypropylene-based plastic can be determined as follows: After the residue mentioned above has been obtained by extraction, it is analyzed by gas chromatography. To prepare it for analysis, a hydrogenation step and a thermal decomposition technique are employed. The above-mentioned residue obtained by extraction with xylene is thus first thermally decomposed at 700° C. Hydrogen gas is then introduced to hydrogenate the thermally decomposed gas. The hydrogenated gas is then analyzed by a G-6800 gas chromatograph (gas chromatograph of the hydrogenation type, produced by Yanagimoto Seisaushoaka). The above-mentioned percentage distribution of the crosslinked starting materials can also be determined by means of C¹³-nuclear resonance microscopy. For example, the quantity of tertiary C atoms to be found in the polypropylene can be determined quantitatively in the insoluble and dried gel component of the plastic foam material. It is advisable in this case to use calibration curves which have been prepared on the basis of copolymers produced from the selected starting resins, namely, statistical copolymers of propylene with ethylene and linear polyethylene copolymers with α-olefins.

It is especially preferred for the polypropylene-based plastic to be in the form of polypropylene and/or of a copolymer of propylene with some other unsaturated comonomer, especially ethylene. The same is also true for the polyethylene; that is, it is preferred for the polyethylene-based plastic to be in the form of polyethylene and/or of a copolymer of ethylene with some other unsaturated comonomer, especially an α-olefin. Preferred unsaturated comonomers include butene, hexene, and octene.

Various additives can be incorporated into the inventive plastic foam material. These include hydrocarbon resins with a melting range of 110-160° C., preferably of 125-150° C.; calcium salts of stearic acid, palmitic acid, and oleic acid and mixtures of these salts with the acids and acid esters; and antioxidants.

These additives can be added to the individual starting materials, i.e., to the polypropylene-based plastic and/or to the polyethylene-based plastic, but they will usually be added during the process of preparing the polymer compound.

It has already been indicated above that it is possible for certain portions of the polyethylene-based plastic and certain portions of the polypropylene-based plastic to be present separately in the inventive plastic foam material. It has been found, for example, that the portion which is based on polypropylene forms the continuous phase, whereas the polyethylene-based plastic forms the dispersed phase.

It is especially advantageous for the melt flow index MFI (230° C./2.16 kg) of the polypropylene-based plastic to be between approximately 0.5 and 12 g/min, especially between approximately 0.4 and 0.9 g/10, and/or for the melt flow index MFI (190° C./2.16 kg) of the polyethylene-based plastic to be between approximately 0.5 and 1.9 g/10 min. It is considered especially advantageous for the melt flow index MFI (190° C./2.16 kg) of the polyethylene-based plastic to be between approximately 0.7 and 1.5 g/10 min, especially between approximately 0.8 and 1.2 g/10 min.

In the production of the plastic foam material, the procedure to be followed according to the invention is essentially the same as that described above in conjunction with the explanation of the disclosure of EP 0,704,476 B1. An essential additional concept will be discussed in greater detail further below. Thus, first, a sheet or some other molded part is produced from the starting materials by a process such as extrusion. Then a source of ionizing radiation, especially a source of electron beams, is used to produce the crosslinking. The type of crosslinking agent incorporated into the starting materials is crucial to the quality of the product. It is always preferable to use such an agent. It has been found that crosslinking agents in the form of divinylbenzene, ethylvinylbenzene, trimethylolpropane triacrylate, trimethylolpropane trimethacrylate, 1,6-hexanediol diacrylate, 1,2,4-triallyl trimellitate, and/or triallyl isocyanurate are especially advantageous. For the purposes of the invention, it is also necessary for a thermally decomposable foaming agent to be used during the production of the desired plastic foam material. A preferred foaming agent is an azodicarbonamide, where an azodicarbonamide in the form of 1,1-azobisformamide, benzenesulfonyl hydrazide, and/or toluenesulfonyl hydrazide is especially suitable.

In individual cases it can be advisable, as already mentioned above, to incorporate additional additives into the material. These can be, for example, fillers or pigments, especially in the form of potassium aluminum silicate, talcum, chalk, kaolin, metal oxides, especially titanium dioxide, and/or carbon black. Lubricants are especially important within the scope of the invention; these substances should be added to the starting materials of the plastic foam material according to the invention. The lubricant can be either of the internal or of the external type. Lubricants of both types can also be used together. Especially advantageous internal lubricants have been found to be hydrocarbon waxes with a melting range of 110-160° C., preferably of 125-150° C., and stearic acid esters, palmitic acid esters, and the Ca salts of these organic acids. An especially suitable external lubricant is a solid, metal soap-containing combination lubricant with high-molecular components (complex esters) (yield point/melting point: 105-115° C.).

With respect to the quantity of the lubricant to be used, the invention is not subject to any essential limitation. It is preferred that the internal lubricant and the external lubricant be present in amounts of 1-5 wt. %, especially in an amount of approximately 0.3-2.0 wt. %, in the finished plastic foam material.

It is of technical interest here to know how it is possible according to the invention to produce an advantageous plastic material with the use of a polyethylene-based plastic which has a melt flow index MFI (190° C./2.16 kg) of less than 2 g/10 min, even though this is in direct opposition to the instructions given in the previously discussed EP 0,704,476 B1. The explanation is that the lubricants indicated above are used within the scope of the invention. It can thus be assumed that, through the use of flow aids or lubricants in the polypropylene/polyethylene compound, which contains both a high-molecular polypropylene-based plastic (molecular weight≧250,000) and a polyethylene-based plastic of high molecular weight, the energy input during extrusion in the twin-shaft extruder can be reduced to such an extent that the temperature of the compound is kept under 185° C., which has the effect of preventing the premature decomposition of the thermally sensitive blowing agent, e.g., the azodicarbonamide, during the extrusion process. Alkali and alkaline-earth salts of stearic acid, palmitic acid, or oleic acid and their amides and esters can be used as lubricants or flow aids. High-melting hydrocarbon resins with a melting range of 115-150° C. can be used in addition. In addition to the points to be considered with respect to the previously discussed lubricants or flow agents, it must also be remembered that the melting and mixing zones of the extruder should be designed in such a way that the supplied granulate is melted sufficiently and reliably and that the mixing and melting energy is limited so that the temperature of the compound can be kept reliably below 185° C. The specific energy input via the drive motor of the twin-screw extruder should not exceed 0.145 kWh/kg. A technical explanation has therefore been given above which explains how the invention, in opposition to the instructions of the described state of the art, can be successfully implemented in practice. This technical explanation, however, is not intended to impose any limitation on the invention. Other possibilities remain open.

The inventive plastic foam material can be processed advantageously together with embossed decorative sheet materials in conventional ways to obtain decorative laminates. These laminates are usually processed by deep-drawing to form decorative surfaces on structural components. But components can also be pressed-molded onto them from underneath in suitable molds, or thermoplastic materials can be applied to their rear surfaces by injection-molding to obtain structural components.

In principle, the inventive plastic foam material is especially suitable for the production of foam laminates used in aircraft and motor vehicles as surface coverings for interior linings, especially on dashboards or control panels, on pillars, on side panels of motor vehicles, on door panels, and on glove compartments. They are processed by deep-drawing, by rear-surface press-molding, or by rear-surface injection-molding. It has been found that the inventive plastic foam material has better elongation values at low temperatures and also at room temperature than comparable products which have been produced according to the state of the art and in which a polyethylene-based plastic with a MFI value (190° C./2.16 kg) of more than 2 g/min is used, as demonstrated by the following comparison experiments.

In addition, the particular advantage of the invention is to be seen in the fact that it gives the processor additional flexibility, in that he now has the possibility of using advantageous polyethylene-based plastics with an MFI value (190° C./2.16 kg) of less than 2 g/min, which are excluded by the state of the art.

The invention is explained in greater detail below on the basis of examples and comparison examples:

### EXAMPLES 1-5

### Production of the Inventive Plastic Foam Material

A twin-shaft extruder (temperature control from 160 to 185° C.; speed, 140 rpm) was used. The plastic composition was extruded in the form of a 1-mm thick sheet. This was crosslinked by the action of electron beams from a β-emitter (1.8 MeV system). The beam current applied in the various examples was as follows: Example 1, 2.00 mA/m/min, four times; Example 2, 1.75 mA/m/min, four times; Example 3, 1.5 mA/m/min, four times; Example 4, 1.75 mA/m/min, four times; Example 5, 2.5 mA/m/min, four times. All of the values for current apply to a scan length of 1 m. This was followed by the foaming step, in which the crosslinked compact sheet material was treated at 270° C. in a hot-air oven. The inventive formulations of Examples 1-5 (numerical data in parts by weight) are listed in the following Table I.

TABLE I

| | Formulations | | | | |
|---|---|---|---|---|---|
| | 1 | 2 | 3 | 4 | 5 |
| Statistical copolymer of PP | 70 | 65 | 70 | 65 | 70 |
| with 3 wt. % of PE | MFI = 6 | MFI = 6 | MFI = 6 | MFI = 6 | MFI = 1 |
| MFI determination: | | | | | |
| 230° C./2.16 kg/g per 10 min | | | | | |
| PE copolymer with n-octene | 30 → | 35 → | 30 | 35 | 30 |
| density = 0.930 g/cm³ | MFI = | MFI = | MFI = | MFI = | MFI = |
| MFI determination: | 0.8-1.0 | 0.8-1.0 | 0.8-1.0 | 0.8-1.0 | 0.8-1.0 |
| 190° C./2.16 kg/g per 10 min | | | | | |
| Crosslinking agent | 2.0 | 2.5 | 2.2 | 2.2 | 1.0 |
| (TMPTMA*****) | | | | | |
| Blowing agent | 8.5 | 8.5 | 7.2 | 7.2 | 7.5 |
| (azodicarbonamide) | | | | | |
| Antioxidant | 0.5 | 0.5 | 0.5 | 0.5 | 0.5 |
| Pigment masterbatch, black | 2 | 2 | 2 | 2 | 2 |
| Lubricant 1* | 1.0 | 1.0 | 0.6 | 0.6 | 0.6 |
| Lubricant 2** | — | — | 1.0 | 1.0 | — |
| Lubricant 3*** | — | — | — | — | 1.0 |

Notes:
*Solid metal soap-containing combination lubricant with high-molecular components (complex esters); yield/melting point, 105-115° C.; acid number <12; Ca content, 1.4-1.6%; flash point >260° C.
**Hard paraffin with a high melting point of 104-110° C., white, pure crystalline; flash point >280° C. an acid number <0.1; viscosity at 120° C., 10 mPa · s.
***Tough-elastic wax with a high melting point of approximately 150° C. and a density of 0.94.
****Pentaerythritol tetrakis (3-(3,5-di-tert-butyl-4-hydroxyphenyl)propionate.
*****Trimethylolpropane trimethacrylate.

The foam properties of the plastic foam material according to Examples 1-5 according to the invention are presented in the following Table II:

TABLE II

| Properties | 1 | 2 | 3 | 4 | 5 |
|---|---|---|---|---|---|
| Density, kg/m³, | 65 | 77 | 60 | 80 | 66 |
| ISO 845 | | | | | |
| Thickness, mm | 2.1 | 2.02 | 2.2 | 2.2 | 2.1 |
| Tear strength, kPa | | | | | |
| According to ISO | | | | | |
| 527-3/test pieces | | | | | |
| DIN 52,920 | | | | | |
| Room temperature | 1,374 | 1,779 | 1,290 | 1,373 | 1,331 |
| (20° C.) | | | | | |
| 120° C. | 499 | 623 | 471 | 509 | 490 |
| 150° C. | 81 | 189 | 61 | 83 | 83 |
| Elongation, % | | | | | |
| According to ISO | | | | | |
| 527-3/test pieces | | | | | |
| DIN 52,910 | | | | | |
| Room temperature | 270 | 247 | 280 | 241 | 283 |
| (20° C.) | | | | | |
| 120° C. | 442 | 296 | 520 | 407 | 443 |
| 150° C. | 173 | 189 | 161 | 197 | 209 |
| Shrinkage, %, | 2.7 | 2.7 | 2.5 | 2.6 | 2.7 |
| 130° C./24 hr | | | | | |
| Compression set, % | 37/25 | 38/27 | 35/24 | 36/28 | 34/26 |
| 50% deformation, | | | | | |
| after 0.5/24 hr | | | | | |
| Gel content, % | 38.5 | 53 | 45 | 49 | 39 |
| 145° C./24 hr | | | | | |
| in xylene | | | | | |

Plastic foam materials which are of practical value with respect to the essential characteristics can thus be produced.

### COMPARISON EXAMPLES 1 AND 2

### Production and Properties

The formulations of Comparison Examples 1 and 2 can be derived from the following Table III:

TABLE III

| | Formulations | |
|---|---|---|
| | 1 | 2 |
| Statistical copolymer of PP with 3 wt. % of PE | 70 | 65 |
| MFI determination: 230° C./2.16 kg/g per 10 min | MFI = 6 | MFI = 6 |
| PE copolymer with n-octene; density, 0.936 g/m³, | 30 | 35 |
| MFI determination: 190° C./2.16 kg/g per 10 min | MFI = 6 | MFI = 6 |
| Crosslinking agent (TMPTMA) | 2.2 | 3.0 |
| Blowing agent (azodicarbonamide) | 8.2 | 8.5 |
| Antioxidant (Irganox 1010) | 0.5 | 0.5 |
| Pigment masterbatch (black) | 2.0 | 2.0 |
| Lubricant 1 (Loxiol G78) | 1.0 | 1.0 |
| Lubricant 2 (Loxiol G22) | — | — |

Notes:
With respect to the crosslinking agent, the antioxidant, and lubricants 1 and 2, refer to the notes concerning the inventive formulations given above.

The comparison sheets were formed by extrusion in the same way as in Examples 1-5, and crosslinking was accomplished in a 1.8-MeV system. In Comparison Example 1, 2.0 mA/m/min, four times, was used; and in Comparison Example 2, 2.1 mA/m/min, four times, was used. The material was also foamed in the same way as that described in Examples 1-5. The following Table IV lists the properties of the plastic foam materials obtained according to Comparison Examples 1 and 2.

TABLE IV

| Properties | 1 | 2 |
|---|---|---|
| Density, kg/m³, ISO 845 | 67 | 65 |
| Thickness, mm | 1.95 | 2.1 |
| Tear strength, kPa | | |
| According to ISO 527-3/test pieces | | |
| DIN 52,920 | | |
| Room temperature | 1,230 | 1,463 |
| 120° C. | 500 | 398 |
| 150° C. | 75 | 98 |
| Elongation, % | | |
| According to ISO 527-3/test pieces | | |
| DIN 52,910 | | |
| Room temperature | 205 | 212 |
| 120° C. | 495 | 240 |
| 150° C. | 180 | 129 |
| Shrinkage, %, 130° C./24 hr | 2.5 | 2.6 |
| Compression set, % | 37/28 | 37/24 |
| 50% deformation, after | | |
| 0.5/24 hr | | |
| Gel content, % | 46 | 56 |
| 145° C./24 hr in xylene | | |

1. Plastic foam material based on polyolefins containing 50-90 wt. % of polypropylene-based plastic and 10-50 wt. % of polyethylene-based plastic with a melt flow index MFI (190° C./2.16 kg) of less than 50 g/10 min, where the plastic foam material has a density of 0.03-0.2 g/cm³, characterized in that 20-70 wt. % of the plastic foam material consists of a crosslinked polyolefin component, in that the polyethylene-based plastic has a melt flow index MFI (190° C./2.16 kg) of less than 2 g/10 min and more than 0.05 g/10 min, and in that the polypropylene-based plastic has a molecular weight (weight-average molecular weight) of 150,000-600,000 g/mol.

2. Plastic foam material according to claim 1, characterized in that the polypropylene-based plastics have a molecular weight (weight-average molecular weight) of 150,000-450,000 g/mol).

3. Plastic foam material according to claim 2, characterized in that the polypropylene-based plastics have a molecular weight (weight-average molecular weight) of 150,000-300,000 g/mol.

4. Plastic foam material according to claim 3, characterized in that the polypropylene-based plastics have a molecular weight (weight-average molecular weight) of 150,000-250,000 g/mol, especially of less than 230,000 g/mol.

5. Plastic foam material according to at least one of the preceding claims, characterized in that the crosslinked polyolefin component contains 55-95 wt. % of polypropylene-based, crosslinked plastic and 5-45 wt. % of polyethylene-based crosslinked plastic.

6. Plastic foam material according to at least one of the preceding claims, characterized in that the polypropylene-based plastic is in the form of polypropylene and/or of a copolymer of propylene with some other unsaturated comonomer, especially an α-olefin.

7. Plastic foam material according to at least one of the preceding claims, characterized in that the polyethylene-based plastic is in the form of polyethylene and/or of a copolymer of ethylene with some other unsaturated comonomer, especially an α-olefin.

8. Plastic foam material according to at least one of the preceding claims, characterized in that a polyethylene-based plastic is dispersed in a continuous matrix based on the polypropylene-based plastic.

9. Plastic foam material according to at least one of the preceding claims, obtainable by crosslinking with a source of ionizing radiation, especially with a source of electron beams.

10. Plastic foam material according to at least one of the preceding claims, characterized in that it contains a crosslinking agent.

11. Plastic foam material according to claim 10, characterized in that the crosslinking agent is selected from: divinylbenzene, ethylvinylbenzene, trimethylolpropane triacrylate, trimethylolpropane trimethacrylate, 1,6-hexanediol diacrylate, 1,2,4-triallyl trimellitate, and/or triallyl isocyanurate.

12. Plastic foam material according to at least one of the preceding claims, obtainable with the use of a thermally decomposable foaming agent.

13. Plastic foam material according to claim 12, characterized in that the foaming agent is an azodicarbonamide compound.

14. Plastic foam material according to claim 13, characterized in that the azodicarbonamide is 1,1-azobisformamide, benzenesulfonyl hydrazide, and/or toluenesulfonyl hydrazide.

15. Plastic foam material according to at least one of the preceding claims, characterized in that the melt flow index MFI (230° C./2.16 kg) of the polypropylene-based plastic is between approximately 0.5 and 12 g/10 min, especially between approximately 0.4 and 0.9 g/10 min, and/or in that the melt flow index MFI (190° C./2.16 kg) of the polyethylene-based plastic is between approximately 0.5 and 1.9 g/10 min.

16. Plastic foam material according to claim 15, characterized in that the melt flow index MFI (190° C./2.16 kg) of the polyethylene-based plastic is between approximately 0.7 and 1.5 g/10 min, especially between approximately 0.8 and 1.2 g/10 min.

17. Plastic foam material according to at least one of the preceding claims, characterized in that it contains an antioxidant.

18. Plastic foam material according to at least one of the preceding claims, characterized in that it contains a filler.

19. Plastic foam material according to claim 18, characterized in that the fillers are present in the form of potassium aluminum silicate, talcum, chalk, kaolin, metal oxides, especially titanium dioxide, and/or carbon black.

20. Plastic foam material according to at least one of the preceding claims, characterized in that it contains a lubricant.

21. Plastic foam material according to claim 20, characterized in that it contains an internal and/or an external lubricant.

22. Plastic foam material according to claim 21, characterized in that the internal lubricant is a high-melting paraffin wax, especially one based on polypropylene or polyethylene, and/or the external lubricant is a metal soap-containing combination lubricant.

23. Plastic foam material according to one of claims 20-22, characterized in that it contains the lubricant in an amount of approximately 1-5 wt. %, especially in an amount of approximately 0.3-2.0 wt. %.

24. Use of a plastic foam material according to at least one of the preceding claims, especially in the form of deep-drawn molded parts, in airplanes and motor vehicles and for interior linings or parts of linings in motor vehicles, especially for coverings on dashboards or control panels, pillars, side-wall panels, door panels, glove compartments, and/or exterior panels.
